(19) United States
(12) Patent Application Publication
(10) Pub. No.: US 2004/0164062 A1
(43) Pub. Date: Aug. 26, 2004

(54) Machine for laser beam processing of oblong workpieces

(75) Inventor: Alfred Horisberger, Butzberg (CH)

Correspondence Address: WEINGARTEN, SCHURGIN, GAGNEBIN & LEBOVICI LLP, TEN POST OFFICE SQUARE, BOSTON, MA, 02109, US

(73) Assignee: Bystronic Laser AG

(21) Appl. No.: 10/686,202

(22) Filed: Oct. 15, 2003

(30) Foreign Application Priority Data
Oct. 21, 2002 (DE) 102 49 106.2

(51) Int. Cl. B23K 26/08

(52) U.S. Cl. 219/121.82; 219/121.78

(57) ABSTRACT

The machine (1) has a receiving device (13) for clamping the workpiece (14) on one side. A laser optic (12) is movable NC-controlled in the three spatial coordinates x, y, and z for processing the workpiece (14). An additional slide (21) may be displaced longitudinally in a controlled way on the base (3) of the machine frame (2). The slide (21) has a carrier plate (29) having multiple attachment elements, arranged in a regular raster, for replaceable, removable attachment of at least one auxiliary device (37), e.g., a support element (39). In this way, the machine (1) is usable in manifold ways. The quality of the processing may be improved through improved positioning and support of the workpiece, and the clock frequency may be elevated.

The present invention relates to a machine tool according to the preambles of claims 1 and 2.

The starting material of oblong workpieces, i.e., of workpieces whose length is a multiple of the dimensions in cross-section, is frequently delivered in the form of rod material or even in the form of strip material and supplied to a machine tool for processing. For lathes and automatic lathes, supplying the starting material to the machine directly, or even automatically, and clamping it therein via suitable clamping means (chucks with turning jaws, collet chucks, etc.) during processing and also for cutting to length, is known. The use of loading and unloading devices in connection with metal-cutting machine tools is also generally known.

A slide (also referred to as a carriage or moving unit) which slides on guides has been suggested for the laser beam processing of oblong workpieces (European Patent Application A2 0 901 874). The slide, which is provided with a roller conveyor and whose operating height may be set, is displaceable in the lengthwise direction of the machine tool via chains and an electric motor positioned in the frame of the machine tool and is used for positioning workpieces using grippers and for unloading. Pneumatically operated clamping means are provided on one side of the machine and a further device for unloading shorter workpieces is provided on the diametrically opposite side.

It is the object of the present invention to provide a device, usable in manifold ways, which is compact and may dispense with an unloading device positioned outside of it.

In addition, the object of the present invention is to be adaptable to specific processing procedures, and/or is to allow these to be optimized in relation to the clock frequency of the machines and/or the quality of the processing. In addition, workpieces of different profile shapes must be able to be processed, particularly hollow profiles such as round, quadrilateral, and polygonal profiles.

This object is achieved by the characterizing features of claims 1 and 2.

Preferred refinements of the present invention are described in the dependent claims.

The features of claims 3 and 7 allow a standardized construction of the additional devices in regard to their mounting on the carrier plate.

The features of claim 4 allow very simple adaptation of the machine to different workpiece profiles.

Using the flexible line according to claim 5, power and control signals may be transmitted to the slides.

The embodiment according to claim 6 prevents the accumulation of particles and the condensation or precipitation of vapors which arise during laser processing, particularly within hollow profiles to be processed.

The characterizing features of claims 1 and 8 produce higher precision in the positioning of the slide in the lengthwise direction of the machine.

The embodiment of the carrier according to claims 9 or 10 elevates the positioning precision of the auxiliary device mounted thereon.

In the following, exemplary embodiments of the present invention are described on the basis of the drawing.

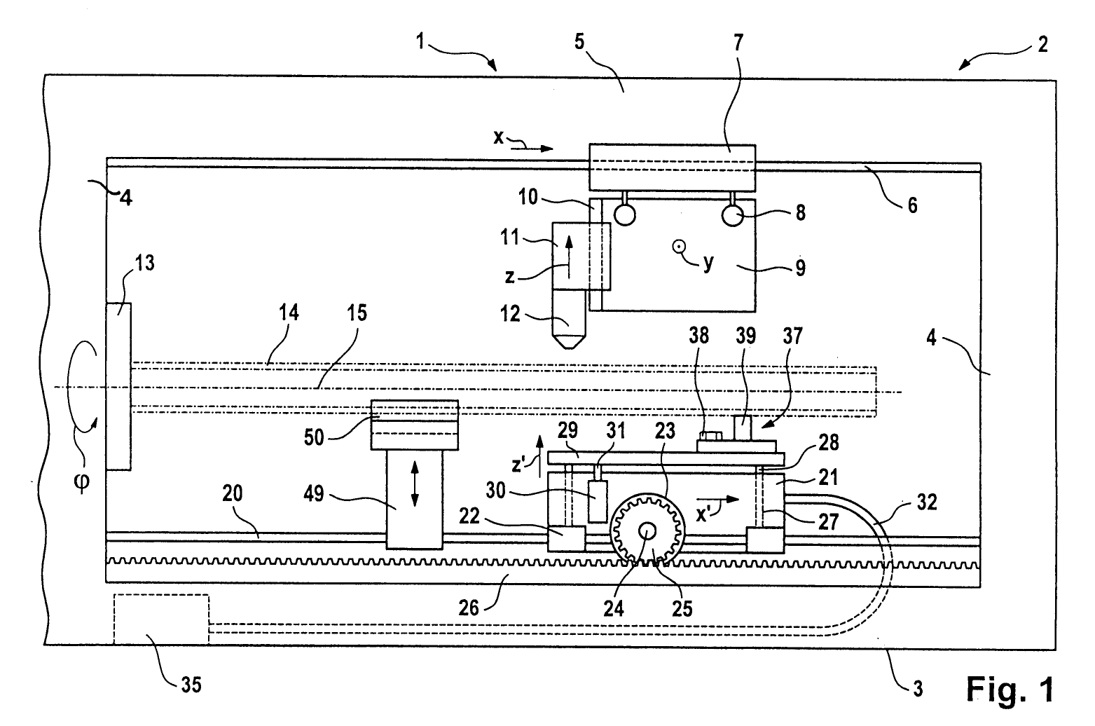

FIG. 1 shows a side view of a laser beam machine tool and

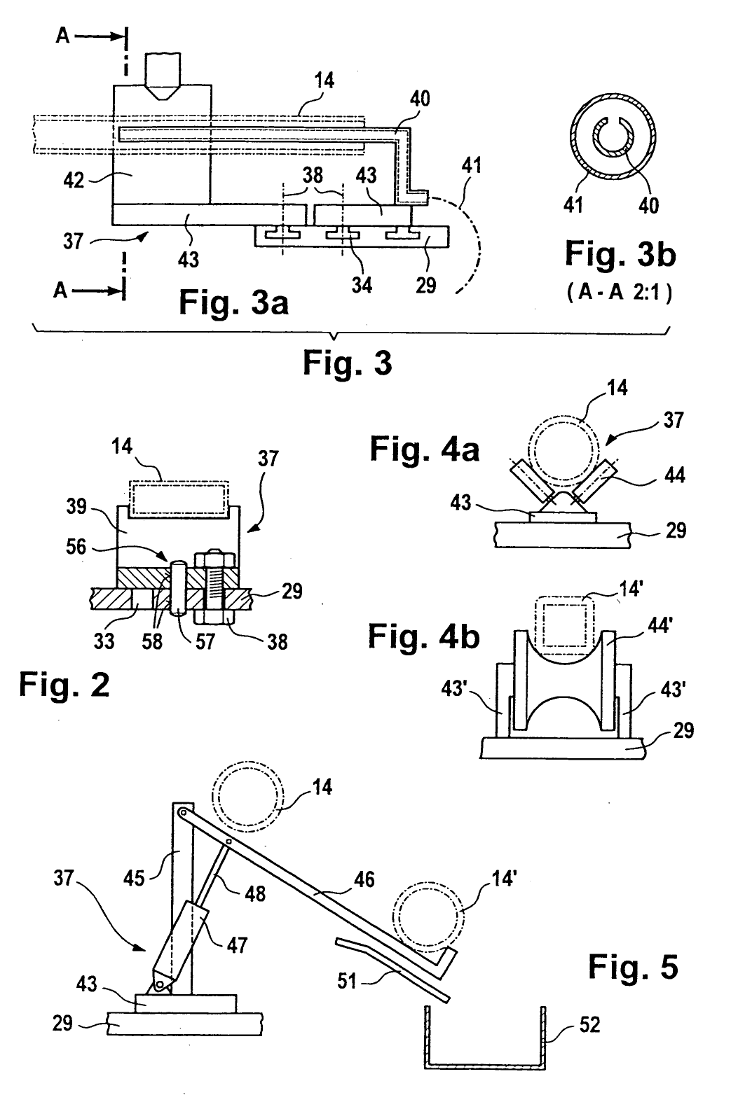

FIGS. 2-5 show details of different auxiliary devices for the machine tool shown in FIG. 1.

The machine 1 shown in FIG. 1 has a frame 2 having a base 3, two stands 4, and a longitudinal carrier 5 connecting them. Two parallel guide rails 6 are attached to the carrier 5, on which a slide 7 is displaceable in the lengthwise direction x of the machine 1. The slide 7 carries two horizontal rails 8, which run perpendicularly to the rails 6. A second slide 9 is displaceable on the rails 8 in the direction y perpendicular to the plane of the drawing. The slide 9 has rails 10, which run perpendicularly to the rails 6, 8, and on which a third slide 11 is displaceable in the direction z. The three slides 7, 9, 11 are positioned in a way known per se by servomotors (not shown here) in the three NC axes x, y, z. A laser optic 12 for processing the workpiece 14, e.g., for cutting or welding, is attached to the slide 11.

The oblong workpiece 14, e.g., a profiled rod, a profiled tube, or a cylindrical tube, is clamped on one side in a clamping chuck 13. The chuck 13 is mounted rotatably in the left stand 14 around a horizontal axis 15, which is parallel to the rails 6. The 13 is connected to a further servomotor (not shown). The rotational angle φ of the 13 is also controlled numerically and forms the fourth NC axis.

Two straight rails 20, which run parallel to the rails 6 and to the axis 15, are attached to the base 3. A slide 21 is displaceably guided on the rails 20 using roller linear guides 22. A servomotor 23, e.g., a stepping motor, is attached to the slide 21. A geared wheel 25, which engages with a toothed rack 26, is seated on its driven shaft 24. The toothed rack 26 runs parallel to the guide rails 20 and is attached to the base 3.

Cylindrical rods 28 are displaceably guided in vertical holes 27 of the slide 21. The rods 28 are attached to a horizontal carrier plate 29. The servo drive for the vertical position of the plate 29 is symbolically shown in FIG. 1 by a servo cylinder 30 having piston rod 31. The servo drives 23, 30, 31 for the additional NC axes x′, z′ of the carrier plate 29 are controlled via a flexible line 32 by an NC control unit 35, fixed to the frame, which also controls the remaining NC axes x, y, z, φ.

At least one of different auxiliary devices 37 is alternately mounted removably and replaceably on the carrier plate 29. For this purpose, the flat plate 29 has, for example, through holes 33 and/or threaded holes in a regular, square raster for receiving screws 38 (FIG. 2), or undercut grooves such as T-grooves 34, positioned in a raster (FIG. 3), or dovetail grooves for receiving screwheads or nuts of the attachment screws 38. In order to position the auxiliary device 37 on the carrier plate 29, the plate has a row of centering holes 56 at the interval of the raster of the through holes 33. A cylindrical pin 57 is inserted into two of these centering holes 56. A centering hole 58 of the same nominal diameter as the hole 56 and the pin 57 is provided in each auxiliary device 37; as well as an oblong hole of the same width in which the second centering pin 57 is guided. The centering holes 56 may also be identical to a row of the through holes 33. Stud bolts, known per se, which allow especially rapid mounting of the components and provide sufficient centering precision, have also proven themselves.

As shown in FIGS. 1 and 2, the auxiliary device 37 may be a support and centering device 39 for the workpiece 14, for example. In this way, the precision of the laser processing by the laser optic 12 may be significantly increased, particularly in the event of a large projection, i.e., in the event of a large distance of the optic 12 from the chuck 13, because the workpiece 14 is supported and centered directly at the optic 12.

As shown in FIG. 3, the auxiliary devices 37 may also include a hollow lance 40, which allows suctioning of the particles, vapors, and gases arising during laser cutting out of the inside of a hollow profile 14. For this purpose, the hollow lance 40 has an end section parallel to the axis 15 and the rails 6, 22, and its free end faces toward the chuck 13. The tubular hollow lance 40 is attached to a carrier 43 and is connected via a flexible hose 41 to a suction fan (not shown). The carrier 43 is attached using the screws 38 to the carrier plate 29.

As shown in FIG. 3, another carrier 43 may carry deflection plates 42, which deflect or guide the workpiece out of the machine after the processing and cutting to length.

In the variant shown in FIG. 4a, the workpiece 14 is a circular cylindrical tube. It is supported and centered by circular cylindrical backup rollers 44, which are rotatably mounted on the carrier 43 around axes slanted by 45°. This variant makes loading and supporting the still unprocessed workpiece 14 easier. Simultaneously, it is used for centering before clamping of the chuck 13, and for moving the slide 21 in the x′ direction without causing abrasion on the workpiece 14.

The further variant FIG. 4b is especially suitable for rectangular profiles 14′, these resting on a concave backup roller 44′ having bearing bracket 43′.

The auxiliary device 37 for collecting workpieces 14 which have been cut to length is schematically shown in FIG. 5. After a section of the workpiece 14 has been completely processed, the slide 21 is moved under the lengthwise center of this section and this section is cut off using the laser optic 12. The completely processed workpiece 14, which has been cut to length, falls onto finger-like collection rails 46. These are slanted periodically, so that the workpieces 14′ slide or roll downward to a stop. The upper ends of the collection rails 46 are pivotably attached to a stand 45. The stand 45 is attached to the carrier 43, which is in turn removably screwed onto the carrier plate 29 of the slide 21. The collection rails 46 may be pivoted downward out of the basic position shown using a piston-cylinder unit 47, 48 linked to the carrier 43 and the rails 46.

In an embodiment which is not shown, the piston-cylinder unit is dispensed with and the corresponding collection rails are connected directly to the base 43.

Two slanted ejectors 51, whose lower ends discharge into an available collection container 52, are attached on the base 3 of the frame 2 in the region of one final position of the slide 21. Starting from its free end, individual sections of a clamped long tube 14 are completely processed, cut to length, and collected step-by-step using the collection rails 46. After the slides 7, 21 have arrived in the region of the chuck 13, the slide 21 travels into the region of the ejectors 51 and the collection rails 46 are lowered, so that the ejectors 51 eject the completely processed tube pieces 14′ into the collection container 52.

Because multiple completely processed short workpieces 14′, which have been cut to length, may be produced and temporarily stored in the same clamping of the long workpiece blank 14 in the clamping chuck 13, the unproductive intermediate times for unclamping, repositioning, and clamping the workpiece blank 14 in the chuck 13 are dispensed with, so that the productivity of the machine 1 is increased. Particularly if a support and centering device 39, 44, as shown in FIGS. 2 or 4a, 4b, for example, is also mounted on the carrier plate 29 in addition to the collection rails 46, high precision of the processing may be ensured in this case, even in the event of a long projection of the workpiece 14.

As may be seen, the additional slide 21 requires hardly any additional space in the machine tool 1. An additional unloading device positioned outside the machine 1 may be dispensed with. Because of the universal attachment possibilities of the auxiliary device 37 on the carrier plate 29, the machine tool 1 may be adapted very rapidly and at low cost to altered processing procedures or requirements. The quality of the processing may be improved and the clock times may be reduced.

Of course, auxiliary devices 37 other than those shown may also be mounted on the carrier plate 29. An example of these is an automatic workpiece changer, as is known in metal-cutting machine tools, for example. For certain applications, it may be expedient if the carrier plate 29 is displaceably controlled analogously to the slide 9, using a transverse slide, in an additional NC axis y′, which is perpendicular to the NC axes x′ and z′.

A centering tip (called a quill) may also be mounted on the slide 21. It may be advantageous for especially long and thin-walled profiles to use a second slide 49 having backup rollers 50, corresponding to the illustration in FIG. 1. This may be moved to its position by hand, but may also be equipped with an autonomous drive and may be displaced by the same controller as the slide 21.

1. A machine tool for processing oblong workpieces (14), particularly tubes, flat profiles, and hollow profiles, using laser beams, a receiving device (13) for clamping the workpiece (14) on one side and, in the region of the laser beam processing, a slide (21), displaceable on guide rails (20) in the lengthwise direction of the machine tool (1), being provided, characterized in that an autonomously controllable drive (23) is provided on this at least one slide (21; 49), its power take-off (24) is provided with a geared wheel (25) and engages in a toothed rack (26) positioned in the lengthwise direction of the machine tool, and the slide (21; 49) is the carrier (29) of supports (39) and/or guides (44) or trays (46) and/or ejectors (51) and/or suction devices (40, 41), which support, guide, receive, and/or eject the workpiece (14) to be processed and/or the already processed workpiece (14′).

2. The machine tool for processing oblong workpieces (14) using laser beams, particularly tubes, flat profiles, and hollow profiles, a receiving device (13) for clamping the workpiece (14) on one side and, in the region of the laser beam processing, a slide (21), displaceable on guide rails (20) in the lengthwise direction of the machine tool (1), as well as a drive (23) for the lengthwise displacement of the slide (21) being provided, characterized in that the at least one slide (21; 49) has a carrier (29; 50) having multiple attachment elements (33, 34) for replaceable, removable attachment of at least one auxiliary device (37), particularly a support element (39), a centering element (44), a suction lance (40), a collector (46) for workpieces (14′) which have been cut to length, and/or an ejector (51).

3. The machine tool according to claim 2, wherein the attachment elements (33, 34) are positioned on the carrier (29) in a regular raster.

4. The machine tool according to one of claims 1 through 3, wherein the carrier (29) is movably guided vertically on the slide (21) and is connected to the slide (21) via a lifting element (30, 31).

5. The machine tool according to one of claims 1 through 4, wherein the slide (21) is connected via a flexible line (32) to a control unit (35).

6. The machine tool according to one of claims 1 through 5, wherein the auxiliary device (37) includes a suction lance (40) whose end section runs parallel to the lengthwise extension of the machine tool (1) in the mounted state, and which is connected via a flexible hose (41) to a suction source.

7. The machine tool according to one of claims 1 through 6, wherein the carrier (29) has attachment holes (33) or undercut grooves (34) in a regular raster for receiving attachment screws (38) for the auxiliary device (37).

8. The machine tool according to one of claims 2 through 7, wherein the drive includes a motor (23) attached to the slide (21), on whose driven shaft (24) a geared wheel (25) is attached, which engages with a toothed rack (26), fixed to the housing, which extends parallel to the lengthwise guides (20).

9. The machine tool according to one of claims 1 through 8, wherein the carrier (29) has positioning elements (56) for exact alignment of the auxiliary device (37) on the carrier (29).

10. The machine tool according to claim 9, wherein the positioning elements (56) are centering holes for receiving centering pins (57).

11. The machine tool according to claim 1 or 2, wherein a support (50), whose height is adjustable, is positioned on at least one second slide (49).

12. The machine tool according to claim 11, wherein at least one of these further slides (49) is manually displaceable.
